(19) United States
(12) Patent Application Publication
(10) Pub. No.: US 2024/0180367 A1
(43) Pub. Date: Jun. 6, 2024

(54) FRUIT CUP

(71) Applicant: Claudiney Santos Borges, Spencer, MA (US)

(72) Inventor: Claudiney Santos Borges, Spencer, MA (US)

(21) Appl. No.: 18/074,487

(22) Filed: Dec. 4, 2022

(51) Int. Cl. A47J 43/044; A47J 31/00

(52) U.S. Cl. CPC A47J 43/044; A47J 31/00

(57) ABSTRACT

A novel method of drilling a hole within spherical-shaped fruit or vegetable body where once the hole is successfully drilled, a liquid of the consumer's choice can be poured to enjoy fruit flavored drink. Furthermore, a handle is also provided which can be attached to fruit/vegetables to provide easy drinking.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, ma otherwise reserves all copyright rights whatsoever.

### BACKGROUND

### Field of the Invention

The utility model relates to a juicing equipment field, particularly, a method to perforate hole into a fruit or vegetable and allowing the consumer to pour the liquid of his/her choice for fruit flavored drink. The methodology also includes handle which is attached to fruit/vegetable for ease in drinking.

### Description of the Related Art

With the improvement of the living standard, people pay more and more attention to health, the requirement for green food and beverage is increasing, and people hope to drink green fruit juice anytime and anywhere.

Fruit drink refers to a kind of beverage of squeezing the juice from fresh fruit. The fruit juice of various different fruit contains the nutrition such as different vitamins and is considered to be a kind of healthy and helpful beverage. But fruit drink mostly in the market has coloring agent, sweeteners, thickener, acidity regulator, essence, acesulfame potassium, and Aspartame, etc., which is not only a nutritional deficiency and is unfavorable for health.

Moreover, when people travel or go on a business trip, the purchase of green freshly squeezed juice is inconvenient and extremely expensive, even if the people spend money, the people cannot drink the green juice, and if the people suffer from bad drinks such as overdue drinks, mildewing drinks, going bad tastes and the like, the people can cause physical discomfort such as diarrhea, fever, and other phenomena, so that the economic loss is caused, and the mental loss and psychological shadow are caused.

By looking at prior art multiple advancements can be seen in similar regards. For instance, a Fruit and vegetable juicing cup bearing Chinese patent 2,036,47030 model discloses a fruit and vegetable juicing cup. The juicing cup comprises a cup body, a bowl-shaped juicing female screen, a bowel-shaped juicing male screen and an upper cover. The lower end of the cup body is sealed, and the upper end is open. First external threads are arranged at an opening of the upper portion of the cup body, a lower connection ring is arranged in the middle of the juicing female screen, second external threads are arranged on the upper portion of the juicing female screen, and first internal threads are arranged in the lower connection ring. An upper connection ring is arranged on the upper portion of the juicing male screen, second internal threads are arranged on the lower portion of the upper connection ring, and third internal threads are arranged on the upper portion of the upper connection ring. Third external threads are arranged on the upper cover. The first internal threads are matched with the first external threads, the second internal threads are matched with the second external threads, and the third external threads are matched with the third internal threads which are matched with the first external threads. The juicing cup has the advantages of being easy to produce and not prone to leakage.

A Chinese patent 1,046,27458A relates to a beverage bottle capable of achieving random mixing of three fruit beverages. The beverage bottle comprises a transparent fruit beverage bottle body with scales and a straw fixing piece arranged on a bottle body opening, a telescopic straw is inserted in the straw fixing piece, the beverage bottle body is divided into a closed upper cavity body, a middle cavity body and a lower cavity body by two separating pieces, a cylindrical straight-through pipe is connected between the upper cavity body and the lower cavity body, and the separating pieces and the upper end opening of the cylindrical straight-through pipe are provided with draw inserting holes capable of being open by poking. According to the beverage bottle, three fruit beverages can be drunk alone, and mutual mixing and blending of the three fruit beverages can be achieved. The scales are attached to the bottle body, and precise master of a blending proportion can be achieved.

A Chinese patent 2,033,54213U model discloses a tea cup for fruit juicing. The tea cup comprises an upper cup body and a lower cup body. The upper cup body is through vertically, and the upper end of the upper cup body is connected with an upper cover in a threaded mode. The lower end of the lower cup body is closed. Meanwhile, the lower end of the upper cup body is connected with a bowl-shaped juicing male net in a threaded mode, the upper end of the lower cup body is connected with a bowl-shaped juicing female net in a threaded mode, and the juicing male net and the juicing female net are matched with each other and are connected in a threaded mode. The tea cup for fruit juicing has the advantage that tea leaves can be prevented from soaking for too long, and fruit juicing functions are diverse.

A Chinese patent 2,041,2075U discloses kind of pressure juice dish. Specifically comprise: this dish is made up of plate, pressure juice post; Wherein, be respectively provided with a juice opening at the triangle of plate, its body of the pressure juice post is triangular form, and arranges some grooves on pressure juice post. Novel structure of the present utility model is unique, and design science is reasonable. In application process, to need its fruit head place of the fruit of squeezing to cut until see pulp, then the incision of fruit is aimed at pressure juice post, and with strength toward pressing down, fruit juice is forced out under on pressure and pressure juice post, institute is provided with the effect of some grooves, and flow in plate, after fruit juice has been pressed, the fruit juice in plate is poured into other containers along juice opening. Whole expressing process is convenient and swift, does not consume energy, safety and environmental protection. Meanwhile, the utility model cost of manufacture is low, convenient and practical during application, and clean, sanitary, and market prospects are very good.

A Chinese patent 2,032,63000U relates to a portable juice extracting cup that comprises a cup body and a cup cover. The portable juice extracting cup is characterized in that the cup body is divided into a cup body part and a cup bottom part, the lower portion of the cup body part is provided with a connecting ring of internal threads, the internal threads are connected with external threads above the cup bottom part in a screwed mode, the portion, along the center, of the connecting ring is provided with an inverted polygonal cone-shaped protrusion, and the cone-shaped protrusion is provided with a round hole. The cup is inverted, the cup bottom part is screwed off, pulp of fruit such as an orange or a lemon which is cut into halves is inserted to the cone-shaped protrusion, juice can flow out and flow into the cup body part through the round hole, then the cup bottom part is screwed, and the cup is shaken so that more juice can be mixed into the cup and mixed evenly with other liquid such as water or milk. The portable juice-extracting cup is simple in structure and convenient to use, and industrialized mass production can be achieved easily.

All of the inventions listed above and many others enlisted in the prior art have multiple complexities with a specific set of features but none of the inventions provide an assembly that has been designed to provide an effective and cheap solution for converting the vegetable or fruit into a cup and provides an option of poring liquid like water/alcohol in it. None of the previous inventions and patents, taken either singly or in combination, is seen to describe the instant invention as claimed. Hence, the inventor of the present invention proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The invention's primary object is advancement in offering fruit-flavored drinking cup with multiple features.

It is further the objective of the invention to provide a fruit and vegetable cup that has the characteristics of a hole drilled within the fruit and a liquid can be poured to enjoy fruit flavor.

It is also the objective of the invention to provide an easy-to-prepare assembly where a handle is provided that can be attached to the fruit/vegetable for drinking.

It is further the objective of the invention to provide an aesthetically pleasing and easy method where various fruit flavors can be enjoyed with a drink of any choice.

It is the further objective of the present invention to provide an assembly that is not easy to leak. Since the fruit body is a unitary structure, there is no joint portion in the middle portion, so no leakage occurs.

It is further the objective of the invention to provide high-quality materials that are also FDA approved to maintain its hygienic level.

It is further the objective of the invention to provide a sleek but sturdy handle to create a strong grip and convenience in holding.

It is also the objective of the invention to provide portability. Being a sleek design and light-in-weight, the assembly enables a user to take it on business trips, vacations, and the like so that the requirement of fresh drink can be achieved anywhere required.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the complete view of the assembly incorporating the embodiments of the invention.

FIG. 2 shows the handle to drink from the fruit as per preferred embodiments of the invention.

The apparatus and method components have been represented where appropriate by conventional symbols in the drawings, showing only those specific details

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. The current invention in its preferred embodiment aims to provide a much easier way to enjoy the flavor of any type of fruit or vegetable while an additional drink can be poured through the hole performed within the fruit/vegetable in a novel way.

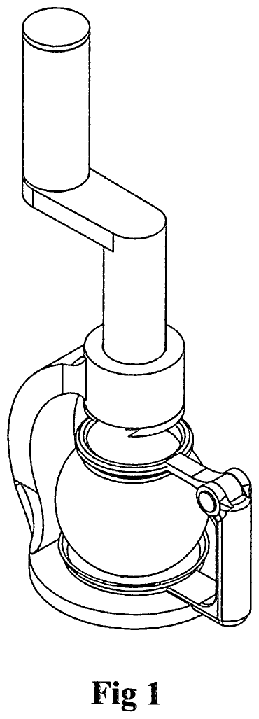

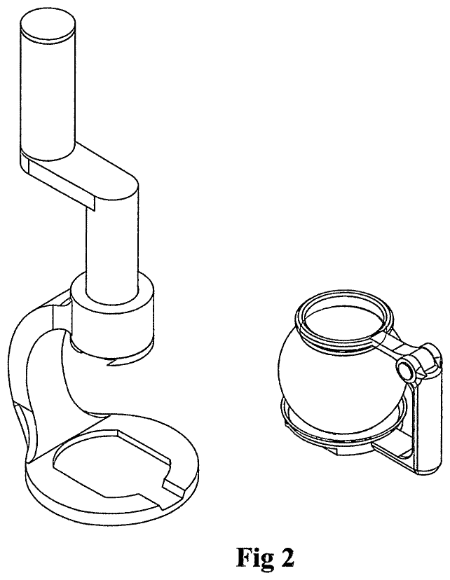

The assembly as per its preferred embodiments provides an assembly to spin. This assembly is connected with a blade to perforate the spherical-shaped fruit/vegetables. Once the fruit/vegetable is perforated, a liquid of the consumer's choice can be poured. Furthermore, a handle can be attached to hold and sip the drink. The assembly's structure can be further understood by looking at FIG. 1 and FIG. 2.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A fruit-flavored drinking cup mechanism wherein the structure includes:
Spinning assembly;
Blade to perforate; and,
Handle to drink from fruit.
The fruit juice cup as per claim 1, allows to drill hole in fruit or vegetable;
The fruit juice cup as per claim 1, allows liquid to be poured into the hole;
The fruit juice cup as per claim 1, wherein the liquid can be of any type including but not limited to water, alcohol, tea, coffee, and so on;
The fruit juice cup as per claim 1, wherein once the hole is being drilled a handle is placed so the fruit or vegetable is ready to be enjoyed as a cup with a handle.
